(19) United States
(12) Patent Application Publication
(10) Pub. No.: US 2004/0232866 A1
(43) Pub. Date: Nov. 25, 2004

(54) Method for monitoring a machine

(75) Inventors: Stephan Greff, Erlangen (DE); Klaus Hertinger, Erlangen (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen, DE

(21) Appl. No.: 10/843,874

(22) Filed: May 12, 2004

(30) Foreign Application Priority Data
May 12, 2003 (DE) 103 21 241.8

(51) Int. Cl. G05B 13/00; G05B 23/02

(52) U.S. Cl. 318/565

(57) ABSTRACT

One or more machine elements of a machine can be moved relative to a base by one or more position-controlled drives. The location of the machine element and control commands for the drives are transmitted to a monitoring unit. The monitoring unit determines based on the control commands a velocity profile for the machine element, wherein the magnitude of the velocity profile and its time derivative are limited. The monitoring device also determines based on the velocity profile a time dependence of the volumes that the machine elements and/or the base occupy before and during the execution of the control commands. Potential collisions between the machine element and at least the base are monitored based on the volumes.

### CROSS-REFERENCES TO RELATED APPLICATIONS

This application claims the priority of German Patent Application, Serial No. 103 21 241.8, filed May 12, 2003, pursuant to 35 U.S.C. 119(a)-(d), the disclosure of which is incorporated herein by reference.

### BACKGROUND OF THE INVENTION

The present invention relates to a method for monitoring a machine, and more particularly for using a monitoring unit to monitor collisions between one or more machine elements and a machine base based on a determined velocity profile.

Methods for monitoring machines, in particular machine tools, to prevent collisions between moving components and/or the workpiece and stationery machine components are generally known. Collisions can be caused, for example, by operating errors or programming errors.

Conventionally, a machine operation can be monitored by installing limit switches in the machine tool, which disconnect the drive when certain operating states of moving elements reach limit values. Likewise, it is known to have the operating program monitor axial movements and to switch off the drive when predetermined positions are reached. Alternatively or in addition, the motion paths can be monitored to ensure that the associated paths are located outside predefined protected spaces.

The afore-described methods are performed online, i.e., while the machine tool machines the workpiece. When monitoring collisions off-line, machining the workpiece is simulated by taking into account the volume of the tool, of the workpiece and of the machine tool.

The conventional monitoring methods have in common that even when monitoring is comprehensive, collisions cannot be entirely prevented. The afore-described online methods also do not take into account changes of the workpiece volume due to machining.

It would therefore be desirable to provide a monitoring method for monitoring a machine that obviates prior art shortcomings and can reliably prevents collisions between components of the machine while a workpiece is machined.

### SUMMARY OF THE INVENTION

The present invention is directed to systems and devices that can reliably prevent collisions between the various components of a machine or machine tool. In particular, a monitoring unit is provided that uses a velocity profile to monitor potential collisions between at least the machine base and at least one machine element.

According to one aspect of the invention, a method for monitoring a machine includes the steps of moving at least one first machine element relative to a base of the machine with at least one position-controlled first drive, and transmitting to a monitoring unit a location of the at least one first machine element and control commands to be transmitted to the first drive. The monitoring unit determines a velocity profile for the first machine element based on the control commands to be transmitted, wherein the determined velocity profile limits the magnitude of the velocity profile as well and the magnitude of a temporal change of the velocity profile. The monitoring unit further determines based on the determined velocity profile a time dependence of a volume that the first machine element takes up before and during execution of the control commands to be transmitted, and determines a volume that is associated with the base before and during execution of the control commands to be transmitted. Based on the determined volume, the monitoring unit monitors collisions between at least the base and the first machine element.

The method according to the invention takes into account, on one hand, the dynamic characteristic of the first drive by limiting the velocity and acceleration profile and, on the other hand, the actually required volumes of the machine element and the base. Optionally, the volumes associated with additional elements, for example a workpiece, can also be considered.

The monitoring method can be flexible if the volume of the base is time-dependent. In particular, the volume of the base can include a time-independent basic volume and at least one activatable and deactivatable additional volume.

This approach can advantageously be used to model a situation where at least one second machine element can be moved relative to the base by a second drive that is not position-controlled. The additional volume can be activated when the at least one second machine element travels beyond a end position and is deactivated when the at least one second machine element reaches the end position.

The monitoring method of the invention can be used in particular with a machine tool. In this case, the first machine element machines a workpiece, causing a volume change in the workpiece. Advantageously, a volume can be associated with the workpiece before and during execution of the control commands to be transmitted. The first machine element can change the volume of the workpiece when the workpiece is machined, and the monitoring unit can dynamically adjust the volume associated with the workpiece if the volumes associated with the first machine element and the workpiece overlap.

Alternatively, the monitoring unit can determine a volume change per unit time of the workpiece based on the dynamical adjustment of the volume of the workpiece, and can compare the volume change per unit time with at least one desired value. The control commands to be transmitted to the first drive or to a drive of the workpiece can be adapted based on this comparison. The monitoring device can thereby optimize the operation of the machine tool.

According to another advantageous embodiment of the invention, the monitoring unit can dynamically adapt the volume associated with the first machine element in the event of an overlap. This can be used to model, for example, abrasion of a grinding disk or wear of a milling head.

Advantageously, the location of the first machine element can be an actual state. Alternatively, the location of the first machine element can also be a desired state or a desired state determined based on a desired value.

The monitoring method can be executed in real-time and online while the machine is operating. In this case, the monitoring method operates particularly reliably if the control commands of the monitoring unit that are to be transmitted are executed with a time lead, which is selected so that the monitoring unit is finished monitoring collisions before the control commands are transmitted to the first drive.

The time lead of the monitoring unit can be defined by a user. Alternatively or in addition, the time lead can depend on an operating state of the machine.

Advantageously, a signal that is characteristic for an operating state of the machine can be transmitted to the monitoring unit. Depending on this characteristic signal, a maximum possible or permissible velocity or a time derivative of the maximal possible or permissible velocity, such as the acceleration or the jerk, can be varied or limited and used to adjust the first machine element.

In the simplest situation, the monitoring unit can transmit a warning message to a user or to a controller that controls the first drive, and optionally also to a second drive. Advantageously, the monitoring unit can adaptively correct the control commands to prevent a collision. The user can be offered to accept the adaptively corrected commands when operating off-line and optionally also during setup.

Advantageously, a characteristic volume can be associated with the first machine element, wherein the characteristic volume can be time-dependent. The first machine element can also include additional elements which can be moved by drives without position control relative to a main section of the first machine element. In this case, the characteristic volume can include a time-independent basic portion and at least one time-dependent additional portion. The additional portion or portions can be changed by activating and deactivating these portions.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram of a machine tool;

FIG. 2 is a process flow diagram for checking the machine tool of FIG. 1 for potential collisions between machine components; and

FIG. 3 is an additional process flow diagram with a variable volume rate.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

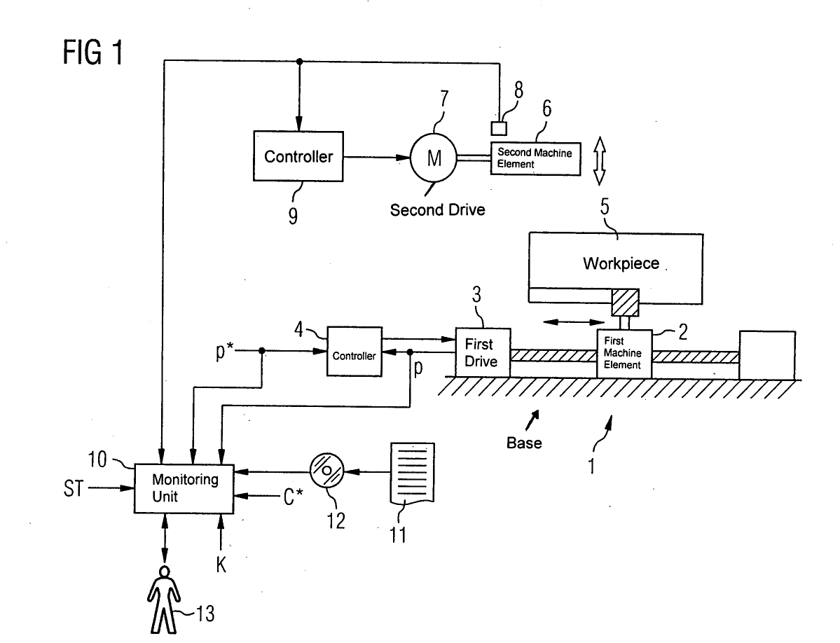

Turning now to the drawing, and in particular to FIG. 1, there is shown a schematic diagram of a general machine, for example a machine tool, that includes a base 1 and at least one first machine element 2 with can be moved relative to the base 1 by a first drive 3. The first machine element 2 is typically a component of the machine. However, this is not required.

The first machine element 2 can be moved by the first drive 3 under position control. Accordingly, an actual location value and a desired location value for the first machine element 2 can be supplied to a controller 4 for the first drive 3, so that the first drive 3 can move the first machine element 2 according to these values. The actual location value as well as a desired location value can be any value within a continuous range. The controller 4 can be implemented, for example, as a numerical controller 4.

Referring back to FIG. 1, the first machine element 2 is, for example, a tool 2 that can be used to machine a workpiece 5, whereby the volume of the workpiece 5 can change. For example, the tool 2 can be a milling head 2. The workpiece 5 can be connected with the base 1, with a moveable machine element of the machine, or with an external element. The machine in the depicted exemplary embodiment is a machine tool. However, this is not required.

At least one additional (second) machine element 6 can be moved relative to the base 1 by a second drive 7. The second machine element 6 is typically also a component of the machine. However, this is also not required. In the present embodiment, the second machine element 6 is, for example, a tool changer or a transport arm for supplying a workpiece 5 to be machined or to remove a machined workpiece 5.

The second machine element 6 is moved without controlling its position. For example, a limit switch 8 determines only that the second machine element 6 has left or reached an end position, which is then indicated to a controller 9 for the second drive 7. The controller 9 for the second drive 7 can be implemented, for example, as a stored-program controller 9. Alternatively, the controller 9 can be a stand-alone unit or combined with the controller 4 into a single unit.

The first machine element 2 should be moved so as to reliably prevent the first machine element 2 from colliding with the base 1 as well as with the second machine element 6. Collisions with other moveable elements should also be prevented. For this purpose, a monitoring unit 10 is provided which is typically implemented as a conventional computer. The monitoring unit 10 can be either a stand-alone unit or can be integrated in the controller 4 and/or the controller 9.

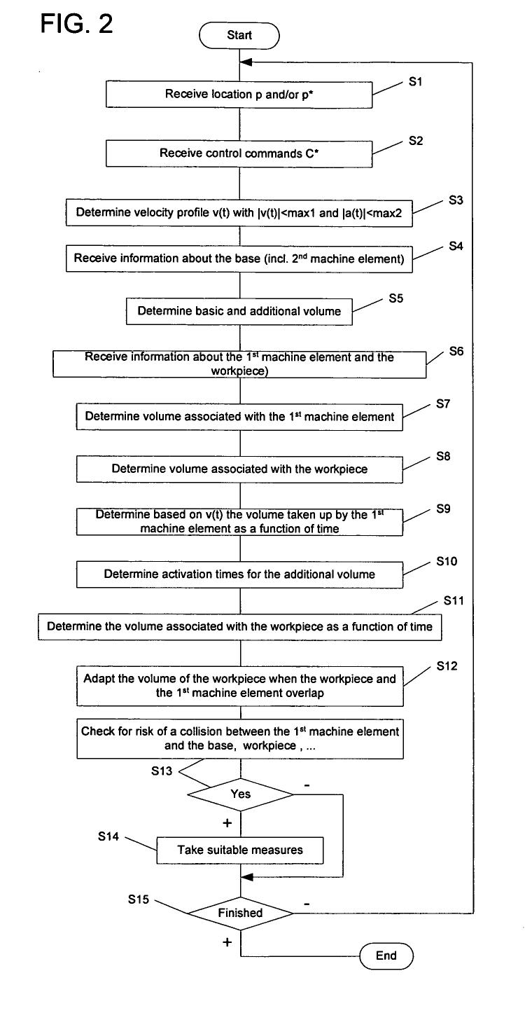

The monitoring unit 10 is connected with the controller 4 and the controller 9 for data transfer. The monitoring unit 10 is programmed with a computer program 11 which is stored in machine-readable form of a data carrier 12, for example a CD-ROM 12. The monitoring unit 10 programmed with the computer program 11 performs the monitoring process which will be described hereinafter in detail with reference to FIG. 2.

Referring now to FIG. 2, the monitoring unit 10 is initially provided in step S1 with a location state p, p* for the first machine element 2. The location state p, p* can be a state that is determined based on a part program according to DIN 66025. In this case, the location state is also a desired state determined based on a desired value.

In step S2, the monitoring unit 10 receives in addition control commands C* which are later outputted to the first drive 3 in order to move the first machine element 2 from the desired location state p or p*.

In step S3, the monitoring unit 10 determines based on the outputted control commands C* a velocity profile v(t) for the first machine element 2. The velocity profile v(t) is hereby determined by the monitoring unit 10 so that the magnitude of the velocity profile v(t) is limited. The velocity profile v(t) is also determined so as to limit the magnitude of the time change a(t) of the velocity profile v(t), i.e., the acceleration a(t). The monitoring unit 10 also takes into account as a limiting factor the dynamic capabilities of the first drive 3 when determining the velocity profile v(t).

In step S5, the monitoring unit 10 also receives information, for example based on known machine data, which the monitoring unit 10 can then use to determine a basic volume and an additional volume for the base 1. In step S6, corresponding information regarding the first machine element 2 and the workpiece 5 are also defined for the monitoring unit 10. In this way, the monitoring unit 10 can also determine volumes, which the first machine element 2 and the workpiece 5 occupy before and during the execution of the control commands C*, steps S7 and S8. The volumes can be preset, for example, by way of a 3D-scan or by programming in an expanded syntax according to DIN 66025+.

Each of the determined volumes is time-dependent for the following reasons:

The volume associated with the base 1 includes the basic volume and the additional volume. The basic volume is time-independent. The additional volume itself is also time-independent. However, the additional volume can be activated or deactivated depending on the operating state of the second machine element 6. If the limit switch 8 detects that the end position has been exceeded, then the additional volume is activated. Conversely, the additional volume is deactivated, when the limit switch 8 detects that the end position has been reached.

The volume associated with a workpiece 5 is initially variable because the workpiece 5 itself can also be moved. In particular, the volume of the workpiece 5 changes when the workpiece 5 is machined by the tool 2 (=the first machine element 2). This volume change is also taken into account.

The volume associated with the first machine element 2 can also be time-dependent because the first machine element 2 moves according to the velocity profile v(t) determined in step S3.

Optionally, for a particular configuration of the first machine element 2, the volume of the first machine element 2 alone, hereinafter referred to as intrinsic volume, can also be time-dependent. For example, if the first machine element is implemented as a wood cutting module, such module has typically several cutters or drills that can be extended or retracted relative to the basic component of the first machine element 2. In this case, a time-independent basic portion of the intrinsic volume is associated with the basic component of the first machine element 2. An additional portion is associated with each additional drill or cutter. The corresponding additional portions are activated or deactivated depending if the drill or cutter is extended or retracted.

Regarding the first machine element 2, the monitoring unit 10 determines in step S9 based on the determined velocity profile v(t) a time-dependent curve of the volume that the first machine element 2 takes up before and during the execution of the control commands C*. Regarding the base 1, the monitoring unit 10 determines in step S10 a volume which will be associated with the base 1 before and during the execution of the control commands C*. Regarding the workpiece 5, the monitoring unit 10 determined in step S11 a volume that is taken up by the workpiece 5 before and during the execution of the control commands C*.

If the volumes of the first machine element 2 and the workpiece 5 overlap, then the monitoring unit 10 dynamically adapts the volume associated with the workpiece 5 in step S12. I.e., step S12 takes into account machining of the workpiece 5 by the tool 2. Optionally, the volume associated with the tool 2 can also be dynamically adapted.

The monitoring unit 10 checks in step S13 if the volume associated with the first machine element 2 overlaps with the volume associated with the base 1 or with another time-dependent or time-independent volume, excluding the volume of the workpiece 5 itself. If this is the case, a collision may occur. Suitable measures for preventing a collision are then taken in step S14. This will be described in more detail below.

If a collision has not been detected in step S13, then it is checked in step S15 if the process is to be continued. If the process is to be continued, the process returns to step S1, otherwise the process is terminated.

Optionally, different measures can be taken in step S14. For example, if the monitoring method according to the invention is performed off-line, then only a warning message may be sent to a user 13. However, if the method is performed online and in real-time, then a warning message can also be transmitted to the controller 4. For example, the controller 4 can stop the first drive 3 to prevent a collision. Other reactive measures, such as shut-down or retraction algorithms, also feasible.

Moreover, the monitoring unit 10 can make adaptive corrections to the control commands C* to prevent a collision. For example, the control commands C* can be corrected so that the first drive 3 adjusts the first machine element 2 faster or more slowly than initially planned.

The afore-described online operation is preferably performed within a so-called preliminary run, which generates the control data for the so-called main run based on a parts program conforming to DIN 66025. Alternatively, the monitoring method according to the invention can also be performed entirely within the main run. In this case, the desired location state p* is directly transmitted to the monitoring unit 10 in step S3.

The monitoring unit 10 requires a certain time for monitoring collisions. In online operation, the control commands C* are transmitted to the monitoring unit 10 with a time lead δt, which is a greater than the time required by the monitoring unit 10. This ensures that the monitoring unit 10 has finished monitoring for collisions before the control commands C* are transmitted to the first drive 3. The time lead δt can be preset in the monitoring unit 10 by a user 13.

Alternatively, the time lead δt can also be automatically determined by the monitoring unit 10. In particular, the time lead δt can depend on an operating state of the machine. For example, the monitoring unit 10 can receive a signal K that is characteristic for the operating state of the machine. The maximum possible or permissible velocity v(t) with which the first machine element 2 can be moved, can be varied or limited according to the signal K. The signal K can be, for example, a certain gear ratio, the presence of a synchronization signal (for example, “drill chuck closed”) or another signal. The monitoring unit 10 can determine a greater or smaller time lead δt depending on the maximum possible or permissible velocity v(t). Other time derivatives, for example the acceleration a(t) or the jerk, can be varied or limited as an alternative to the afore-described variations of the velocity v(t).

Alternatively, in particular during setup, the user 13 can interactively input the control commands C* in the monitoring unit 10. In this case, the location state p based on which the monitoring unit monitors collisions, is the actual location state p of the first machine element 2. Preferably, only a warning message is sent to the user 13, and no other measures are taken. The user 13 can identify based on his understanding of the necessary adjustment process if an actual collision risk exists or if the monitoring unit 10 is only theoretically unable to completely exclude the risk of a collision.

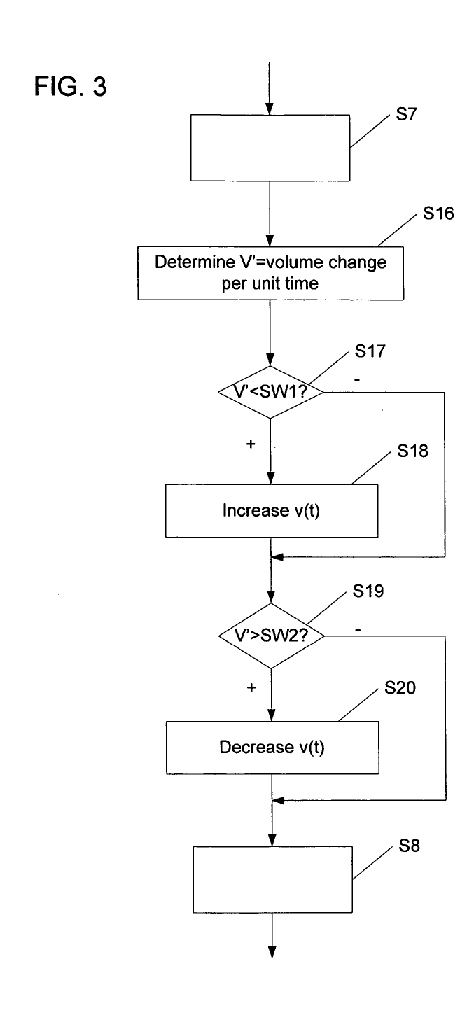

As illustrated in FIG. 3, additional steps S16 to S20 can be inserted between the steps S7 and S8 when the workpiece is machined.

In step S16, the monitoring unit 10 determines a volume change V′ of the workpiece 5 per unit time based on the modification of the volume of the workpiece 5. In step S17, the monitoring unit 10 compares the determined volume change V′ with a first desired value SW1. If the volume change V′ is less than the first desired value SW1, then the control commands C* are changed in step S18 so as to increase the displacement velocity v(t) of the tool 2.

In step S19, the monitoring unit 10 compares the volume change V′ with a second desired value SW2. If the volume change V′ exceeds the second desired value SW2, then the control commands C* are changed in step S20 so as to reduce the displacement velocity v(t) of the tool 2. The velocity v(t) used to machine the workpiece 5 with the tool 2 can be optimized by this process. Alternatively or in addition to the afore-described optimization of the control commands C*, other control commands to be transmitted to another drive for the workpiece 5, e.g., for a holder for the workpiece 5, can also be optimized.

The monitoring method according to the invention is therefore capable of reliably preventing a collision. Those skilled in the relevant art will appreciate that in practice the machine can have more than one adjustable position-controlled first machine element 2, for example several first machine elements 2 for adjusting the tool relative to the workpiece 5 in three dimensions, with additional rotation. A number of additional machine elements 6 can also be controlled by the (stored-program) controller 9. Optionally, one or more workpieces can be machined simultaneously using several tools 2. It will be understood that all such adjustments have to be measured and their mutual interaction has to be taken into account. Although this increases the complexity of the monitoring method in practice, the underlying principle according to the invention remains the same.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for monitoring a machine, comprising the steps of:
moving at least one first machine element relative to a base of the machine with at least one position-controlled first drive; and
transmitting to a monitoring unit a location state of the at least one first machine element and control commands to be transmitted to the first drive,
wherein the monitoring unit
determines a velocity profile for the at least one first machine element based on the control commands, with the determined velocity profile limiting a magnitude of the velocity profile as well as a magnitude of a change of the velocity profile with time;
determines based on the determined velocity profile a time dependence of a volume occupied by the at least one first machine element before and during execution of the control commands;
determines a volume associated with the base before and during execution of the control commands; and
based on the determined volume, monitors collisions between at least the base and the at least one first machine element.

2. The method of claim 1, wherein the volume of the base is time-dependent.

3. The method of claim 2, wherein the volume of the base comprises a time-independent basic volume and at least one activatable and deactivatable additional volume.

4. The method of claim 3, wherein at least one second machine element is moveable relative to the base by a second drive that is not position-controlled, wherein it can be determined when the at least one second machine element leaves or reaches an end position, and wherein the additional volume is activated when the at least one second machine element leaves the end position and the additional volume is deactivated when the at least one second machine element reaches the end position.

5. The method of claim 1, further comprising associating a volume with the workpiece before and during execution of the control commands, wherein the at least one first machine element changes the volume of the workpiece when the workpiece is machined, and wherein the monitoring unit dynamically adjusts the volume associated with the workpiece if the volumes associated with the at least one first machine element and the workpiece overlap.

6. The method of claim 5, wherein the monitoring unit determines a volume change per unit time of the workpiece based on the dynamical adjustment of the volume of the workpiece, compares the volume change per unit time with at least one desired value, and based on the comparison adapts the control commands transmitted to the first drive or to another drive of the workpiece.

7. The method of claim 5, wherein the monitoring unit dynamically adjusts the volume associated with the at least one first machine element if the volumes associated with the at least one first machine element and the workpiece overlap.

8. The method of claim 1, wherein at least one of the control commands is interactively defined by a user.

9. The method of claim 1, wherein the location state of the at least one first machine element is an actual state.

10. The method of claim 1, wherein the location state of the at least one first machine element is a desired state or a desired state determined from a desired value.

11. The method of claim 1, wherein the method is performed in real-time and online.

12. The method of claim 11, wherein the control commands transmitted from the monitoring unit are executed with a time lead, said time lead being selected so that the monitoring unit finishes monitoring collisions before the control commands are transmitted to the first drive.

13. The method of claim 12, wherein the time lead of the monitoring unit is defined by a user.

14. The method of claim 12, wherein the time lead depends on an operating state of the machine.

15. The method of claim 1, further comprising the steps of transmitting to the monitoring unit at least one signal that is characteristic for an operating state of the machine; and depending on the characteristic signal, varying or limiting a maximum possible or permissible velocity or a time derivative of the maximal possible or permissible velocity, such as the acceleration or the jerk, used to adjust the at least one first machine element.

16. The method of claim 1, wherein the monitoring unit adaptively corrects the control commands to prevent a collision.

17. The method of claim 1, wherein the monitoring unit transmits a warning message to a user or to a controller that controls the first drive. (claim 4, second drive).

18. The method of claim 1, wherein the monitoring unit transmits a warning message to a user or to a controller that controls the second drive.

19. The method of claim 1, wherein a characteristic volume is associated with the at least one first machine element, said characteristic volume being time-dependent.

20. The method of claim 19, wherein the characteristic volume comprises a time-independent basic portion and at least one time-dependent additional portion.

21. The method of claim 20, wherein the at least one additional portion can be varied by activating and deactivating the at least one additional portion.

22. A computer program stored on a data carrier for performing a monitoring method according to claim 1.

23. A monitoring unit for monitoring a machine, said monitoring unit programmed by a computer program according to claim 22.

24. A machine having a monitoring unit for monitoring collisions between elements of the machine, comprising:
a base;
at least one first machine element movable relative to said base;
at least one first drive for the at least one first machine element; and
a machine controller for position-controlled movement of the at least one first machine element,
wherein the machine controller transmits to the monitoring unit a location state of the at least one first machine element and control commands to be transmitted to the at least one first drive, and
wherein the monitoring unit determines a velocity profile for the at least one first machine element based on the control commands, with the determined velocity profile limiting a magnitude of the velocity profile as well as a magnitude of a change of the velocity profile with time,
wherein the monitoring unit determines based on the determined velocity profile a time dependence of a volume occupied by the at least one first machine element before and during execution of the control commands,
wherein the monitoring unit determines a volume associated with the base before and during execution of the control commands, and
wherein the monitoring unit, based on the determined volume, monitors collisions between at least the base and the at least one first machine element.
